(19) United States
(12) Patent Application Publication
(10) Pub. No.: US 2011/0246010 A1
(43) Pub. Date: Oct. 6, 2011

(54) Technique for Optimizing the Use of the Motor in Hybrid Vehicles

(76) Inventor: Jose de la Torre Bueno, Vista, CA (US)

(21) Appl. No.: 13/076,050

(22) Filed: Mar. 30, 2011

Related U.S. Application Data
(63) Continuation-in-part of application No. 12/710,350, filed on Feb. 22, 2010, now Pat. No. 7,958,958.
Application No. 12/710,350 is a division of application No. 11/450,049, filed on Jun. 9, 2006, now Pat. No. 7,665,559.
(60) Provisional application No. 61/319,194, filed on Mar. 30, 2010.

(51) Int. Cl. B60W 20/00; B60W 40/12; B60W 10/06

(52) U.S. Cl. 701/22; 180/65.245; 180/65.28; 903/902

(57) ABSTRACT

In a hybrid vehicle, selecting the relative usage of the electric motor and the fossil fuel powered engine from moment to moment and also managing the storage of energy in the battery. A computer is used for determining information about a complete trip between a start point and a destination, dividing said complete trip into a plurality of different intervals, and determining, for each of said different intervals, a power level to run the engine at said each of said intervals. An embodiment uses evolutionary computing techniques to determine the most efficient routes.

This application claims priority from provisional application number 61319194, filed Mar. 30, 2010, the entire contents of which are herewith incorporated by reference. This is also a continuation in part of application Ser. No. 12/710,350, filed Feb. 22, 2010, now U.S. Pat. No. ______ which is a divisional of 11450049 filed Jun. 9, 2006, which claims priority from 60639689, filed Jun. 20, 2005.

### BACKGROUND

A hybrid vehicle may operate using both hydrocarbon fuel and electric power. A conventional engine may be fueled by the hydrocarbon fuel. An electric motor is powered by a battery, and can create or supplement the engine's power. There are several levels of hybrid vehicles available or in design. Some definitions:

Basic hybrids will be used to refer to the current generation of hybrid vehicles in which the amount of energy stored as liquid fuel is much greater than the energy capacity of the battery so the vehicle is being propelled by the engine most of the time. The vehicle uses the combined power of both the engine and the motor to achieve acceptable performance in acceleration or hill climbing.

Performance may suffer if the battery is completely drained.

A basic hybrid may use the engine to operate a generator which charges the battery at times when the full power of the engine is not needed to propel the vehicle. During braking the electric motor can also act as a generator and recover kinetic energy to replenish the battery.

Pure hybrids or serial hybrids refer to more extreme hybrid vehicles that are being designed. In these “pure” or all-electric-drive hybrids, one or more electric motors are the only source of power to the wheels. The only function of the engine is to run a generator to charge the battery. In this type of vehicle it is even more important that there always be charge in the battery since the vehicle cannot move at all without it.

In a pure hybrid the battery pack is typically much larger than in a basic hybrid. This design also has the advantage that the engine and generator can run while the vehicle is parked or stopped. Because most vehicles spend more time parked than moving in this kind of hybrid the engine can be much smaller than the engine in a conventional vehicle of the same weight.

Plug-in hybrid means one in which the driver has the option of plugging the vehicle into an exterior electric power when it is parked so that the battery does not have to be charged by the engine. Typically they have larger batteries than a basic hybrid. Of course if the battery is low and the vehicle is not plugged in the engine will power a generator to charge the battery as in a basic hybrid. Since electricity purchased from a utility is much cheaper than hydrocarbon fuels in terms of cost per unit of energy, it is advantageous to the user to charge from the grid as often as possible and minimize times the engine is charging the battery.

A plug-in hybrid often has a larger battery, so that on local trips the vehicle may be able to run on battery power except when maximal power is needed and thus achieve a higher effective miles per gallon of hydrocarbon fuel. The capacity to plug in is a feature that can be added to the other types mentioned above so a plug-in hybrid will also be either a basic or pure hybrid.

Solar hybrids will be used to refer to newly proposed hybrid vehicles which have solar panels on the body to provide part of the electricity for the electric motor.

It is well known that the area available on the top of a typical car is insufficient to provide enough electricity to power the car. In fact, typically the ratio is 1/8 to 1/10 of the area that would be needed to power such a vehicle. On the other hand, a typical car belonging to an individual is parked 90% of the time. Therefore, if the battery is large enough, solar charging could provide a significant portion of the energy used. The currently proposed solar hybrids may also be plug-in hybrids, so if sunlight is unavailable for any reason (weather, parked underground etc.) the battery can be charged from grid power. In addition since it is a hybrid, the battery can always be charged by the engine.

A controller may be formed by one or more processors associated with the vehicle. The controller runs an optimized control algorithm that determines on a moment-to-moment basis when to use either the engine, the motor or both; in what ratio, and also when to charge the battery from the engine. In pure, plug-in and solar hybrids, the controller also makes decisions about how and when to recharge the battery when the vehicle is stopped or parked. The controller may also adjust the transmission and brakes as necessary to maintain optimal efficiency.

In a normal internal combustion vehicle there is no energy stored except in the fuel. The power produced by the engine must be equal to the power necessary to overcome all losses at every moment. The designer of a hybrid vehicle has greater flexibility. A hybrid vehicle includes a motor/generator that can provide some or all of the power needed and a battery which can not only store power in the form of electricity but can effectively be refilled whenever the power necessary to permit the chosen speed is less than the power provided by the motor. If the vehicle is decelerating or going downhill this can be positive even if the motor is off (this is referred to as regenerative breaking).

The motor, engine and generator can be arranged in different ways. For instance, in the Toyota Prius both the motor and the engine are attached mechanically to the driveshaft while in the Chevy Volt the motor powers a generator which charges a battery and all motive power comes through an electric motor connected to this battery. In this patent application we are concerned only with the techniques that select the relative usage of the electric motor and the engine from moment to moment and the storage of energy in the battery. The techniques described here is executed by a computer, and works equally well regardless of the arrangement of the electric motor and the engine.

### SUMMARY

The present application describes new ways of controlling hybrid vehicles to increase the degree of optimization possible.

### BRIEF DESCRIPTION OF THE DRAWINGS

FIG. 1 shows a basic hybrid vehicle; and

FIGS. 2 and 3 show a flowchart of operation; and

FIG. 4 shows a chart of power and fuel.

### DETAILED DESCRIPTION

In this application, the following words may have the following meanings:

Definitions:

Motor: Used here as a short form of electric motor, meaning the one or more electric motors providing motive force to maintain the vehicle at the desired speed. This may be a motor/generator, which recovers energy when the vehicle is decelerating or going downhill.

Engine: Used here to mean an internal combustion engine or a fuel cell or any other device that creates mechanical or electrical power by consuming some fuel. It is assumed that unlike the motor the engine cannot be run backwards to recover energy. The engine may or may not be connected directly to the drivechain.

Fuel: This is used to mean whatever fuel the engine is consuming, examples would include without limitation, gasoline, diesel fuel, alcohol, natural gas and hydrogen.

Series hybrid: A hybrid vehicle in which the engine only charges the battery and all motive power comes from the motor(s). Also known as a range extended electric vehicle.

Interval: The time or distance unit over which engine power is being set by the proposed techniques.

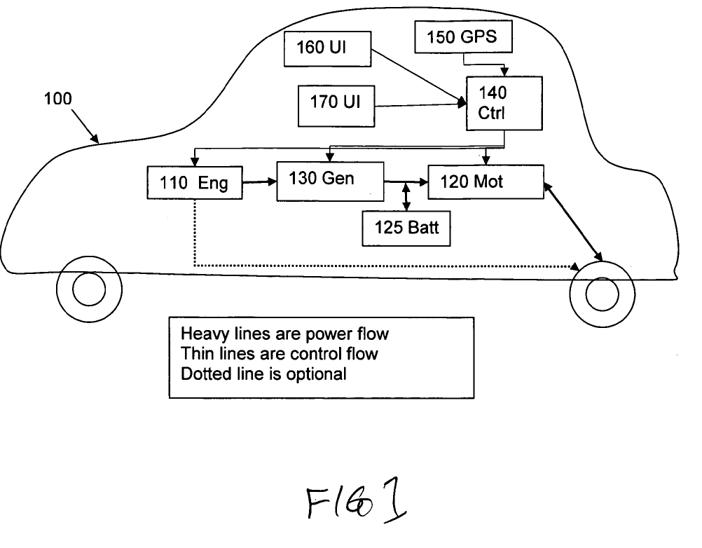

An embodiment as shown in FIG. 1. A hybrid vehicle 100 is shown as an automobile with an engine 110 running on a combustible fuel, e.g., gasoline, and a motor 120, powered by a rechargeable source (here a battery) 125. A generator 130 produces energy to charge the battery, regeneratively or with power from the motor. Note that in some designs the generator and the motor may be the same device. A controller 140 determines how much engine power and/or motor power to use.

Existing designs may use various parameters, including the current and previous position of the gas pedal and brake pedal (which input the driver's intent to the controller), the current and past fuel consumption, the current and past speed and acceleration, and battery charge level as inputs. Note that the “gas pedal” is not actually controlling the fuel pump in some hybrid vehicles, but is taken by the controller as an indication of the driver's desire. Based on this information and the other variables, the controller 140 may control the fuel flow to engine 110, as well as the amount of current delivered to the electric motor 120. The controller may also take other actions, such as shifting the continuously variable transmission.

Other variables may also be used to help the controller 140 in making its decision. These may include the slope of the road, the current temperature and the current air pressure. Variables such as these may form second order influences on the optimization carried out by the controller.

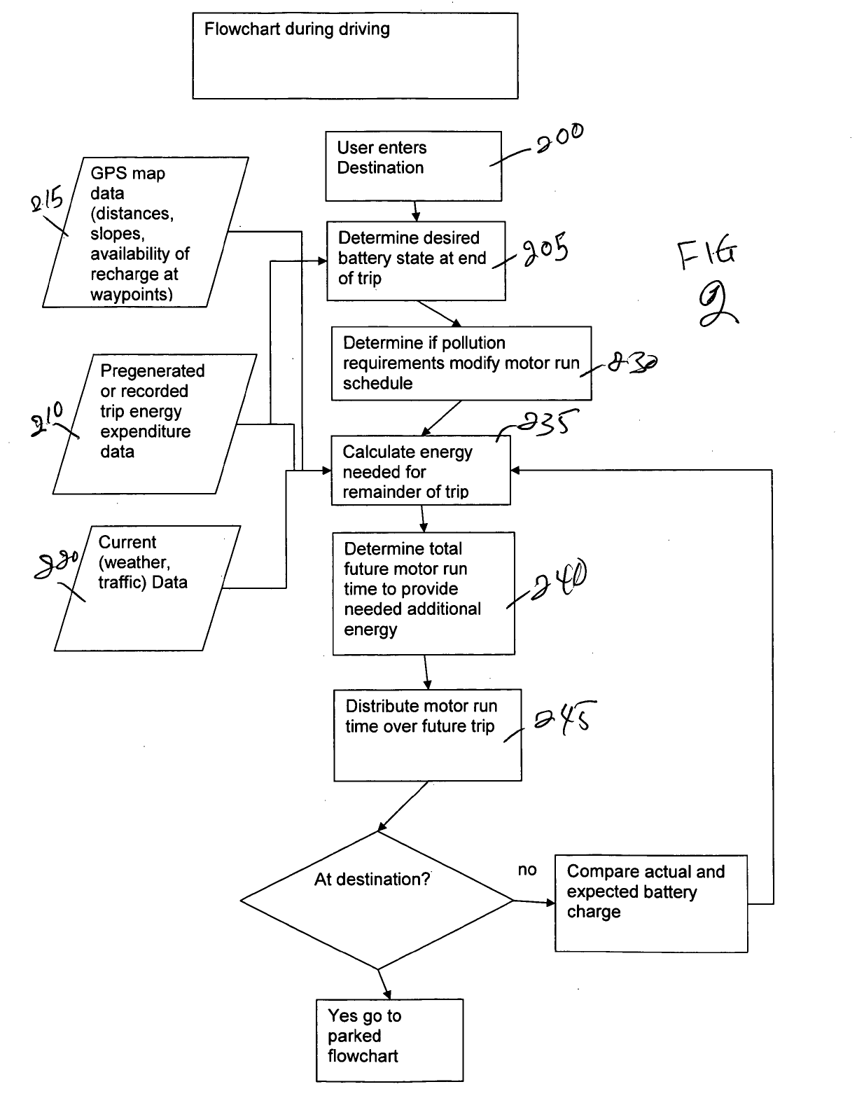

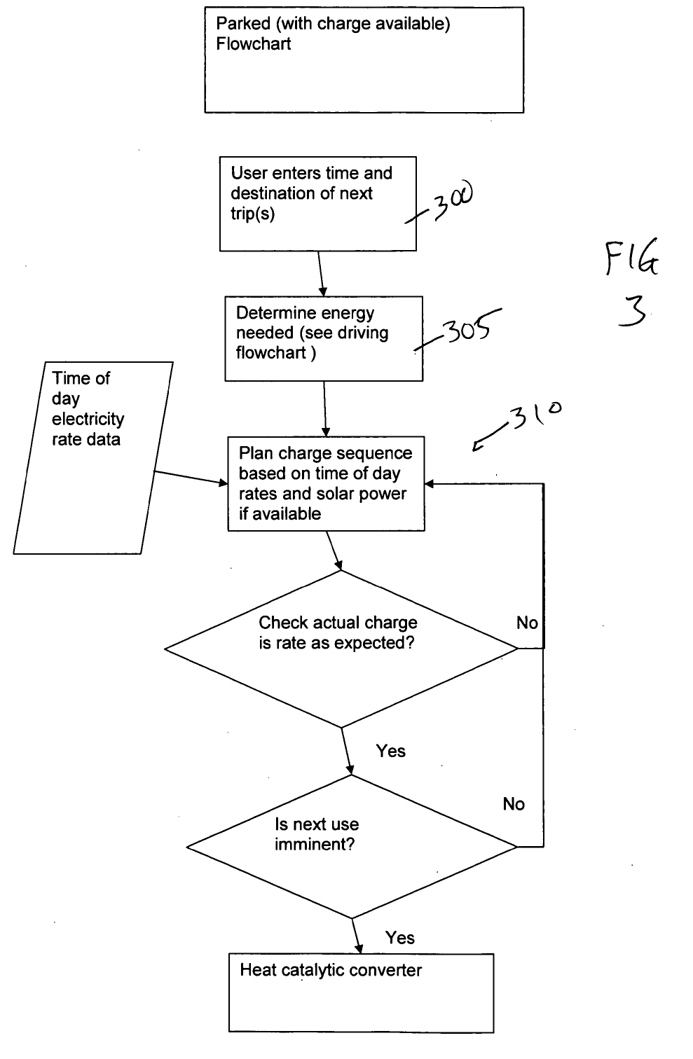

The controller 140 operates according to the flowchart of FIGS. 2 and 3, to determine when to use battery charge, and how much to use. The controller's goal is to use as. much of the battery charge as possible—while never really completely emptying the battery charge.

Consider the decision the controller must make if a hybrid vehicle has climbed a hill steep and long enough that the battery had to be significantly drained to achieve the driver's desired speed. If the vehicle then reaches a level stretch, the controller will detect a need to replenish the battery and will aggressively charge the battery. For example, the controller may run the conventional engine at a level greater than needed to maintain speed in order to have extra power to recharge the battery. Note that this action is triggered by a rule, perhaps the cardinal rule in the controller which dictates that “if the battery is below a certain charge level and the current power requirement is less than the capacity of the conventional engine, then recharge the battery.”

The inventor recognized, however, that recharging the battery at this moment may or may not be the optimum action in terms of fuel economy. If there is another hill coming up, it may be the correct action—otherwise if the battery is not fully charged by the start of the next hill, the vehicle may not be able to climb that at an acceptable speed without the additional energy from the battery. In contrast, if the route is going to go downhill next, the system will have the option of using the electric motor as a brake and recovering energy into the battery for future use. The previous aggressive charging might not have been necessary. Once the battery has been fully charged, the recovered energy is essentially wasted—the controller will have to use the mechanical brake to control the downhill speed and the energy will be lost as heat instead.

The inventor noticed that this less than—optimum decision by the controller algorithm is caused because the controller does not use knowledge of the future path of the vehicle. If there were an input to inform the algorithm of future opportunities to recharge the battery, then a more optimum sequence could be chosen and the net efficiency could improve.

In an embodiment, the controller 110 uses knowledge of the future path of the vehicle as part of its determination of how much battery charge to use at any given time. In an embodiment, the future path is determined from a GPS navigator 150 associated with the vehicle, that communicates with (or is part of) controller 140. In another embodiment, the user manually tells the controller about the trip that is going to be taken. This is generically shown as the “trip energy expenditure data”, 210 in FIG. 2. The controller may determine this based on GPS map data 215, as well as based on dynamic information 220, such as weather and traffic.

In a plug-in hybrid, the problem of the controller not knowing the drivers intent is exacerbated. In proposed designs for plug in hybrids, the suggested algorithm is to use the engine to recharge the battery whenever the battery level is below 40%. This is a safe algorithm but clearly not the most cost efficient possible. Consider the situation in which the driver is on their way to a parking place where grid electricity is available. In this case, letting the battery be run to almost zero as the vehicle arrives is a good strategy,* since it will allow the maximum amount of energy to be obtained and stored at the lower cost—since electricity is almost always cheaper per unit energy than liquid fuels. Under the 40% rule, the controller might be running the engine harder than necessary in order to charge the battery when it is in fact possible to charge the battery from a cheaper source at the destination.

An embodiment describes informing the controller of how far the vehicle must go (as well as the speed and any hills to be climbed) before grid recharging is available. Given this information, the control algorithm becomes able to calculate the energy needed to complete the trip in order to use as much as possible of the energy in the battery so that it could be recharged from the less expensive source.

Another aspect provides information for the controller to know how long grid power is going to be available and how much energy is needed for the next trip.

If time of day metering is available at charging locations, a further cost optimization is possible in plug-in hybrids. Consider the case in which the driver has arrived home and plugged in the vehicle. Should the controller recharge the battery as fast as possible? If the driver intends to use the vehicle again soon, this could be the desired behavior. However, if the vehicle will not be used until the next day and cheaper electricity is available at night, then it might be better to delay recharging until the electricity rate comes down. In the absence of information on when and how the vehicle will next be used, the designer of the algorithm must make pessimistic assumptions which will lead the algorithm to charge the battery as quickly as possible regardless of cost.

This issue of when and from what source to charge the battery is even more complex in a solar hybrid. Consider the scenario in which the driver has commuted to work and parked the vehicle at a spot that has grid power available. Obviously the driver should plug in the vehicle but should the controller begin to draw grid power? Given enough time, the solar hybrid can recharge the battery from the solar collectors on the vehicle but what if the driver intends to make another trip soon? If the battery is not recharged, the next trip will at the least use more engine time and therefore more expensive fuel. Again, lack of knowledge of the driver's future intent forces the designer of the control algorithm to make pessimistic assumptions.

The driver's intent and the vehicle's future path are often available in computer compatible form when the driver is using a GPS navigator. In addition to knowing the current position, a modern GPS stores a map of the area which optionally can include contour information. In order to use the navigation assistance feature of a GPS, the driver indicates the destination at the start of the trip, shown as 200 in FIG. 2. The controller determines the desired end battery state at 205. This may be a set amount, or may be controllable.

In an embodiment, the GPS provides information indicative of the length and contour of the trip (data 215) ahead to the controller as well as continuously updating the controller with the current position. Standard interconnection methods such as Ethernet, USB, infra red, or wireless Ethernet, for example, can be used to communicate between the devices. Alternatively, a dedicated GPS chipset can be associated with the controller. Given the availability of this information, more sophisticated control algorithms can be used.

In the hill example given above, the algorithm can calculate the amount of energy that could be recovered given the contour of the road ahead. If the future path is downhill, that may override the requirement to keep the battery charged to a certain level, thus maximizing efficiency.

If the driver changes the route, this will cause the vehicle's battery to be in a non optimal state; for instance if at the top of the slope posited above, the driver were to leave the programmed route and take a detour that leads further uphill, that driver might be informed that either the speed will be restricted or the vehicle must park while the conventional engine recharges the battery. This may be a worst case cost of the efficiency improvements. If the driver were to begin a trip without indicating a destination to the GPS, the controller might default to the current style of algorithm. The only cost of doing this would be a loss of efficiency; otherwise the vehicle would operate normally.

In the example of the plug-in hybrid approaching its destination described above, the controller could use the current position forwarded by the GPS as well as the information on the distance to the destination and contour of the road ahead to model the energy required to complete the trip. At the moment the computed energy necessary to complete the trip is less than the current energy stored in the battery, the controller could stop using the engine to charge the battery and let it discharge (obviously keeping some minimal reserve level) so that it could accept the maximum charge from the grid recharge point.

A simple form of this optimization could be achieved by giving the driver a control to inhibit further recharging of the battery by the engine. A driver who was familiar with the route could learn when they could activate the switch to optimize use of battery charge. It could become possible to over-drain the battery, but with an attentive driver on a familiar route this would be feasible and would increase efficiency without any modification to the existing controllers.

For the automatic anticipation optimization to work properly, the controller would need to know whether the destination had grid charging available. This information can be available to the controller as a data item on the GPS. In most GPS/electronic map units, the user can have the GPS remember locations and can give the locations (called waypoints) names and in some cases choose a symbol. This may be used to define grid points. Grid points can also be added as “points of interest”. In this method when the driver enters waypoints into the integrated GPS they would indicate whether grid based battery charging was reliably available at each waypoint. When the driver started a trip they would enter the destination waypoint. In this case the control algorithm would know not only the distance and contour to be crossed to get to the destination but whether less expensive recharge for the battery is available. Given this information, the control algorithm could use the engine as little as possible to arrive with some minimal charge in the battery.

If the driver were to input the destination for the next trip and when they expected to start when they leave the vehicle further optimizations are possible. Consider the examples of the plug-in hybrid which is parked overnight. If the driver enters the time they next expected to derive and the controller had access to data on electricity rates, it might calculate that rates would go lower before the time the driver next needed the car and therefore the optimum behavior might be to delay fully recharging the battery until rates go down. For pure hybrids which cannot be used at all if the battery is discharged, the algorithm might be modified to require bringing the battery up to some minimal charge (for instance enough to get to the nearest hospital) as quickly as possible and then doing the rest of the charging during off peak rates.

Knowledge of the time before the vehicle would be next used and the next destination might also improve the optimization algorithms for solar hybrids. Consider the example of the solar hybrid that has just been parked, if the user indicates that the next trip will occur in a short time and will be a long trip the algorithm might dictate recharging the battery right away from grid power even though it is more expensive than sunlight. On the other hand if the user indicates that they will not use the vehicle for 8 hours or the next trip is to another location which also has charging and which the vehicle can reach with the current charge then the control algorithm might conclude that recharging with solar alone is the optimum choice.

Other optimization information may be used as 200. The dynamic information includes information that changes from time to time. The amount of traffic on the road serves as an indication of the probable fuel economy. This data allows more accurately estimation of the energy needed to complete the trip.

Another input is weather, the current and future wind speed and direction along the route will exert a non-trivial effect on energy needed, in addition the future cloud cover is a variable the control algorithm should have in order to decide whether a solar hybrid will be able to recharge from sunlight in the time available.

Future speed can also be used to optimize performance. In certain jurisdictions, real time information on the current average speed of travel for each segment of the local highways is now on the web. This information may be used as part of the model. The data could be distributed in computer readable form such as XML or RSS. If it were, a vehicle equipped with a wireless internet connection could continuously download this information and the control algorithm would be able to estimate future speed as well as distance and hills in optimizing the use of power sources. An internet connection could also be used to download weather forecasts in order to have anticipated wind speed and direction as an input. For the optimization of charging by a Solar Hybrid as described above knowledge of the future cloud cover would be a needed input.

Another embodiment uses stop information as part of the optimization scenario. The stops that a driver plans on making, as well as the estimated time at each waypoint can be used. The controller algorithm may use this information to check that time to charge the battery will be available at a charging waypoint, if not it might still do some charging with the engine. The stops can also be used with solar hybrids, to determine the amount of time for solar charging.

This same information on future use could be used to minimize pollution as well. It is a known property of catalytic converters that they do not work well until they become hot. It has been proposed that as a vehicle is started battery power be used in resistive heating elements to bring the converter up to temperature as quickly as possible in order to minimize pollution caused by short trips. In a plug in hybrid which is trying to maximize the use of the battery the use of electricity to heat something is a poor use of a limited resource. If the driver enters the time the vehicle would next be used when they plug in, the controller could start warming the catalytic converter while the vehicle is still connected to grid power. This would allow the vehicle to start a trip with the battery fully charged and the catalytic converter at optimum temperature.

Another embodiment uses a remote control with which the driver could instruct the controller a few minutes before they leave to activate a preparation sequence which would bring the battery to full charge and heat the catalytic converter.

Another alternative is that the controller more aggressively draws from the battery until the catalytic converter is heated, thereby reducing engine operation and hence reducing engine exhaust via the un-optimized catalytic converter. In this embodiment, the battery use during times of cool catalytic converter is more aggressive than during other times. This is shown generically as 230 in the flowchart.

The control algorithms mentioned above assume that the energy needed to move the vehicle a given speed on a given slope is known. One way of deriving this information is to perform experiments during the design of the vehicle and program the factors so discovered into the controller. If the user is entering the destination into a GPS which is available to the controller more customizable algorithms are possible. The control algorithm could as a side effect of its operation store the energy used for each segment of a trip recording the speed and slope along with the energy used. This data could be averaged and consulted by the algorithm when it needed to compute the energy needed to complete a given trip as described above. The advantage of this method is that the vehicle would in effect learn the driver's habits and the efficiency of the vehicle as it changed over time. Another way to store and use this data would be to record the energy used on each trip averaging trips between the same waypoints together. Most vehicles make the same trips repeatedly so if the driver's input to the GPS indicated a trip for which there were prior records the energy used on the prior trips could be used as an estimate of the energy needed to complete this trip. The advantage of this is again the customization that would occur as the vehicle in effect learned the driver's habits and the local weather and traffic. Further optimization could be achieved by sorting trips by time of day and weather and choosing the historical trips most similar to the proposed trip as the model. This is analogous to the precedent method of weather forecasting.

If the database of previous trips between the same waypoints is large enough the control algorithm would have a higher degree of confidence in the estimated future energy consumption. In this case the controller could compute a confidence factor and could adjust the minimum battery charge to keep based on this factor. That is if the controller has a high degree of confidence in the projected energy use it would allow the battery to discharge to a lower level during the trip. If an adaptive algorithm such as this were used the vehicle would be more efficient on familiar trips. The same applies to projections based on knowledge of the route and the anticipated slopes, traffic and weather. If there is a large database of similar situations the controller could have a higher degree of confidence in the calculated energy requirements.

Another way to have a larger database either of specific trips or performance in various situations is to share with other users of the same type of car. A web based subscription service could be offered in which, the controller uses a wireless internet connection (or any other method of real time communication) to upload the actual energy usage experience on whatever trips it takes. In return controllers belonging to registered users of the site could download information to make better predictions for upcoming trips either examples of the same trip or general data on the energy usage of cars of that model under various conditions of slope speed weather etc.

It should be obvious that other methods of communication could be used to achieve this result including exchanging data before and after trips when non wireless methods are available.

In summary of the above techniques, 235 determines the energy for the remainder of the trip, based on the GPS data. 240 determines the total future motor run time, and 245 allows distributing that run time over the trip.

FIG. 3 illustrate a “parked” flowchart. As described above, this allows obtaining the time and destination of the next trip at 300, determining the energy that is needed for later driving at 305, and then charging at 310.

The inventor has recognized an additional critical Problem to be Solved. Specifically, a critically important feature of any vehicle is how much fuel it consumes to make any given trip. In a hybrid vehicle the designer has the option to choose how much power comes from the engine at any moment. This makes it possible to operate the engine more frequently at its most efficient RPM. In a plug in hybrid, there are effectively two sources of energy; electricity, which can be added directly to the battery when it is plugged in and whatever fuel the engine uses. At this time electricity is significantly less expensive per unit of energy content that most available fuels so the designer of a plug in hybrid would like to design the techniques that decides on the relative rate at which the engine and motor run in such a way as to maximize the use of electricity and minimizes the use of fuel over the course of a trip. This is difficult to do if the future course of the trip is unknown.

The techniques described here builds on the inventions disclosed in the parent patent Inputs for Optimizing Performance in Hybrid Vehicles (U.S. Pat. No. 7,665,559) from which this claims priority. That patent discloses a method of using information from a GPS unit in which the driver has entered the destination as well as information from previous trips and public data sources such as weather and traffic websites to anticipate the power requirements over the course of the trip. The instantaneous power requirement cannot be predicted as it will depend on interactions with other traffic and traffic signals. However, the average power needed over some interval will depend on topography and average speed, which can be predicted.

Knowing the average future requirements for power, there are certain optimizations that can be made. For instance:

In a plug in hybrid it would be desirable to arrive at a location that has charging available with the battery in the lowest possible state of charge so that as much as possible of the total power used was electrical power.

In any hybrid it would be desirable to arrive at the bottom of a hill with the battery in a high state of charge to avoid the requirement to run the engine at a higher and less efficient power level while climbing the hill. If the size of the engine is such that the hill cannot be climbed at a desired speed on engine power alone this is a requirement for acceptable performance. This logic also applies to any portion of the trip to be accomplished at high speed.

It would be desirable to arrive at the top of a hill with a long downhill slope to be traversed with the battery in the lowest state of charge possible so that as much as possible of the breaking energy can be recovered and stored.

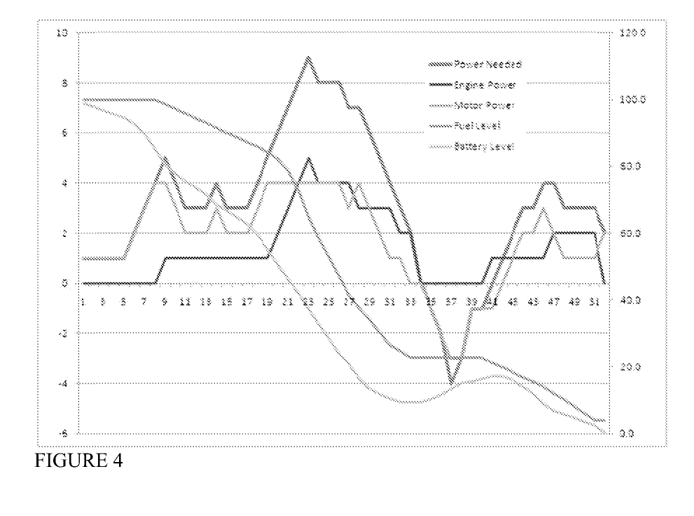

Given the possibilities of optimization, the problem can be generalized to be the selection of some function giving the optimum average power level of the engine as a function of distance along the trip. FIG. 4 shows the relevant functions including the power needed, curved 400, the engine power, curved 410, the motor power, curved for 20, fuel level curve 430, and battery level curve 440.

FIG. 4 shows the Power needed and battery and fuel levels over the course of a trip. FIG. 4 shows that the power needed to accomplish each portion (interval) of the trip has been calculated from the information available from the GPS as disclosed in the embodiment of FIGS. 1-3. This is not instantaneous power, which cannot be predicted, but an anticipated average power needed averaged over some intermediate time or distance scale (for instance tenths of seconds to several minutes or tenths of miles to several miles).

Over any interval, the techniques will choose the average level at which to run the engine. The goal of the techniques is to select a curve for the engine power over trip intervals such that the integrated fuel consumption over the trip is minimized.

The curve to be developed is subject to several constraints:

There is a maximal power that the engine can develop.

There is a curve of engine efficiency as a function of power that will determine the rate of fuel consumption for a given power.

There is a maximal power that the motor can develop.

There is a curve of motor efficiency as a function of power that will determine the rate of electricity consumption for a given power.

There is a maximum rate at which the regenerative breaking system can return energy to the battery and the efficiency of regenerative breaking may vary with the rate power is being returned.

The level of battery charge can never exceed 100% or be less than zero (or some other higher limit selected to maximize battery life). (Unless the techniques is designed to allow a trip that must be finished on engine power alone in a non-series hybrid.)

The fuel level, in general, should be controlled must not go below zero. (Unless the techniques is designed to allow a trip that must be finished on battery power only.)

To accomplish the trip at the assumed speed the power available must be equal or greater than the power required at all times. In a series hybrid this is simply the power of the motor but in a hybrid with a transmission that can combine mechanical power from the motor and engine it is the sum of their powers. (Assuming that both fuel and battery power are available at that moment.)

The techniques may also include further constraints. For instance it might not be desirable to arrive at a destination with the battery at the lowest possible charge level in case the driver needed to make an emergency trip before the vehicle has had time to recharge.

Different characteristics may be used for series as compared with non-series hybrids. In a series hybrid, the engine power level is in some sense buffered from the instantaneous power requirements by the battery so that the engine power level for a given increment of the trip can be considered a constant. In a non-series hybrid the movement of the gas pedal will impose overrides which will bias the power from the long-term optimal levels developed by the techniques.

Even subject to these constraints, there are a very large set of engine power over interval curves that satisfy the constraints. In fact, the set of curves approaches infinity as the variables are considered continuous. The inventor recognizes that the designer must create techniques that will select the curve that results in the lowest possible fuel use over the trip using techniques that can accommodate all of these different possible options.

This is an example of a problem in which evaluating a proposed solution is much easier than analytically solving for an optimal solution. For any given curve of engine power over intervals, it is easy to integrate usage of fuel and check for violations of the constraints. It is much more difficult to analytically solve for a curve that optimizes fuel usage given an arbitrary curve of power required and the curves for engine and motor efficiency.

An embodiment describes techniques that can analytically derive an ideal curve of engine power over intervals. By the use of evolutionary techniques, proposed curves can be generated at random and a good one selected by an evolutionary process.

The techniques work as follows:

The curve of required power over trip intervals would be developed as soon as the driver entered the destination into the GPS as described in the earlier patent. This would take into account the topography over the planned trip, the speed limits of the roads involved, optionally the traffic and weather and optionally the history of actual power usage over earlier trips on the same route.

A large number (hundreds to thousands) of possible curves of engine power level over trip intervals would be generated at random by choosing an engine power randomly from the range of possible engine power levels for each interval. Each of these is a potential solution.

These resultant curves would each be evaluated by assuming that motor power in each interval is equal to the difference between required power in that interval and the engine power. (In a series hybrid the engine power available is zero so all engine power is assumed to go into charging the battery and the motor power must equal the required power). Given motor and engine power these can be multiplied by their efficiencies at the given power levels and integrated to develop the fuel level and battery state of charge.

Some possible curves will result in the violation of one or more constraints at some interval; these potential solutions can be discarded immediately.

The remaining solutions are sorted in order of increasing fuel consumption and a fraction chosen to generate the next generation of solutions starting with the best one. The fraction chosen can be selected to optimize the run time of the techniques but might be one to ten percent.

A new population of possible solutions (curves) is generated by combining features of the selected best solutions from the previous generation. One possible way to do this is to create a member of the next population of potential solutions by selecting two solutions at random from the population of best solutions from the previous generation, picking an interval at random and combining the beginning of one selected solution with the end of the other.

Once a large number of potential solutions have been created return to step 3.

Cycle the techniques between steps 3 and 7 until the best solution ceases to improve or as much time is available has elapsed.

This method will not result in a provably best solution but it will generally arrive at an economically acceptable one in reasonable time. The first solutions generated fully at random will not be very good but as the techniques runs the best solutions in each generation will get better and better. In this application the computer controlling the motor and engine could run this techniques once as the trip starts and then periodically afterwards to adapt the future usage of the motor and engine to actual conditions.

The number of trial solutions in each generation, the number selected to generate the next generation and the method of combining solutions to create the next generation of solutions can all be varied to optimize the speed at which the techniques arrives at an acceptable solution.

For instance when creating the next generation it may be useful to include the very best of the previous generation unmodified. Another variation would be to create a member of the next generation by averaging two selected good members of the previous generation at each interval.

By using these techniques the computer controlling the motor and engine can use anticipatory information about upcoming features of a trip to minimize the use of fuel and make the vehicle have the highest possible miles per gallon and lowest cost to operate. This improves the performance of the vehicle without adding any significant additional hardware.

Another embodiment describes using any other kind of computer algorithm to solve this problem, and preferably one that is adapted for solving problems where the number of possible solutions for those problems approaches infinity, such as the traveling salesman problems.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other devices and other operations can be controlled in this way.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for optimizing use of the engine of a hybrid vehicle to minimize fuel use by maximizing use of electrical energy in the engine, said system using a computer for determining information about a complete trip between a start point and a destination, dividing said complete trip into a plurality of different intervals, and determining, for each of said different intervals, a power level to run the engine at said each of said intervals.

2. A system as in claim 1, wherein said determining uses evolutionary techniques to select the power level at which to run the engine at each interval of a trip.

3. A method of optimizing use of the engine of a hybrid vehicle to minimize fuel use by maximizing use of electrical energy in the engine, comprising:
using a computer for determining information about a complete trip between a start point and a destination, dividing said complete trip into a plurality of different intervals, and determining, for each of said different intervals, a power level to run the engine at said each of said intervals.

4. A method as in claim 3, wherein said determining uses evolutionary techniques to select the power level at which to run the engine at each interval of a trip.
